(19) United States
(12) Patent Application Publication
(10) Pub. No.: US 2026/0019801 A1
(43) Pub. Date: Jan. 15, 2026

(54) SYSTEM AND METHOD FOR TRIGGERING ELEMENTS IN 5G NETWORK

(71) Applicant: JIO PLATFORMS LIMITED, Ahmedabad, Gujarat (IN)

(72) Inventors: Aayush BHATNAGAR, Navi Mumbai, Maharashtra (IN); Mangesh SHantaram KALE, Navi Mumbai, Maharashtra (IN); Gaurav JAIN, Ghansoli, Maharashtra (IN); Anurag SINHA, Mumbai, Maharashtra (IN); Hardik Navinbhai BAVISHI, Navi Mumbai, Maharashtra (IN); Sandeep BISHT, Kalyan Thane, Mahrashtra (IN); Kumar Gaurav SINGH, Panvel, Maharashtra (IN); Nilesh SANAS, Navi Mumbai, Maharashtra (IN); Amit Kumar SINGH, Kalyan East, Maharashtra (IN); Raghvendra BHUSHAN, Kalyan, Maharashtra (IN)

(73) Assignee: JIO PLATFORMS LIMITED, Ahmedabad, Gujarat (IN)

(21) Appl. No.: 18/992,601

(22) PCT Filed: May 7, 2024
(86) PCT No.: PCT/IN2024/050491

§ 371 Date: Jan. 9, 2025

(30) Foreign Application Priority Data
May 30, 2023 (IN) 202321037374

(51) Int. Cl. H04W 8/24; H04W 4/14; H04W 48/16

(52) U.S. Cl. CPC H04W 8/245; H04W 4/14; H04W 48/16

(57) ABSTRACT

The present invention discloses a system (100) and a method for triggering 5G network elements. The system (100) includes an interworking unit to facilitate exchange of messages between a Service Capability Exposure Function (SCEF) and Network Exposure Function (NEF) (114). The system (100) includes the NEF (114) obtains a short message Service Function ID (SMSF ID) associated with a device (for example, a user equipment or a network element) and transmits a request along with the SMSF ID to the SCEF via the interworking unit. The interworking unit receives the request from the NEF (114), converts the request into a format compatible with the SCEF, and transmits the converted request thereto.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to telecommunication networks. In particular, the present disclosure relates to a system and a method for triggering elements in a 5G network. Furthermore, the present disclosure mitigates one or more issues of triggering user equipment (UE) devices and/or network elements in 5G network systems.

### DEFINITION

As used in the present disclosure, the following terms are generally intended to have the meaning as set forth below, except to the extent that the context in which they are used to indicate otherwise.

The expression ‘Application Function (AF)’ used hereinafter in the specification refers to a function that is responsible for providing specific functions or services to applications. These functions or services can include anything from authentication and billing to network slicing and service discovery.

The expression ‘Network Exposure Function’ used hereinafter in the specification refers to a 5G core cloud native network element that securely exposes the network services and capabilities to either third-party applications or the internal Application Functions (AFs) over the Application Programming Interface (API).

The expression ‘Unified Data Management’ (UDM) used hereinafter in the specification refers to a function that manages network user data in a single, centralized way. The UDM is like 4G/LTE's Home Subscriber Service (HSS) but is cloud-native and designed for 5G. The function of the HSS in the 5G network is split into the Authentication Server Function (AUSF) and the UDM. The UDM manages subscriber data for authorization, registration, and mobility management.

The expression ‘Service Capability Exposure Function (SCEF)’ used hereinafter in the specification refers to a component in 4G networks that serves as an interface between network services and third-party applications or services. SCEF is configured to apply device triggering enabling a service capability server (SCS) to send information to the UE through the 3GPP network to trigger the UE to perform application-specific actions that include initiating communication with SCS for the indirect model or an application server (AS) in the network for the hybrid model. An SCEF network communicates with services capability server/application server (SCS/AS) functions using either the T8 otherwise known as the WebSocket representational state transfer (REST)ful application program interface (API) protocols using the DSR API gateway, which provides a proxy API gateway with trusted identity management, IP multimedia subsystem (IMS) access, quality of service (QOS) control, messaging services, and industry-standard security, authentication, accounting, and authorization.

The expression ‘Network Element’ used hereinafter in the specification refers to a fundamental building block or component that performs specific functions within a network. Examples include base stations, routers, switches, and other devices that contribute to the overall functionality of the network.

The expression ‘Short Message Service Function (SMSF)’ used hereinafter in the specification refers to a function that supports the transfer of SMS over NAS. In this capacity, the SMSF will conduct subscription checking and perform a relay function between the device and the SMSC (Short Message Service Centre), through interaction with the AMF (Access and Mobility Management Function).

These definitions are in addition to those expressed in the art.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

5G wireless technology developed in Third Generation Partnership Project (3GPP) was meant to deliver higher multi-Gbps peak data speeds, ultra-low latency, more reliability, massive network capacity, increased availability, and a more uniform user experience to more users. However, as 3GPP standards evolve with time, interworking between specific network entities and elements becomes an issue. For instance, the lack of explicit description of interaction between 4G and 5G nodes including, but not limited to, a Service Capability Exposure Function (SCEF) and a Network Exposure Function (NEF), leads to significant challenges while designing flows and interfaces. While 3GPP briefly touches upon the interaction between Application Function (AF)'s interaction with NEF and SCEF through Control Application Programming Interface Framework (CAPIF), the 3GPP specifications lacks how CAPIF selects between NEF or SCEF. Moreover, AF needs to support N33 and T8 Application Programming Interfaces (APIs). Existing solutions do not provide means for triggering of appropriate 5G network elements.

There is, therefore, a need in the art to provide a system and method that can overcome the shortcomings of the existing systems and methods.

### OBJECTS OF THE PRESENT DISCLOSURE

Some of the objects of the present disclosure, which at least one embodiment herein satisfy are as listed herein below.

An object of the present disclosure is to provide a system and a method for triggering 5G and advanced network elements.

Another object of the present disclosure is to mitigate issues associated with triggering user equipment (UE) or network elements/entities.

Another object of the present disclosure is to handle interworking between Evolved Packet Core (EPC) and 5G core (5GC) in network exposure scenarios.

Another object of the present disclosure is to enable the designing of flows and interfaces between 4G and 5G nodes such as Service Capability Exposure Function (SCEF) and Network Exposure Function (NEF).

Another object of the present disclosure is to provide a system and a method for triggering network elements in 6G and beyond networks.

### SUMMARY

The present disclosure discloses a system for triggering at least one user equipment in a network. The system includes an application function (AF), a network exposure function (NEF), a unified data management (UDM), a service capability exposure function (SCEF), a network element, and a short message service function (SMSF). The application function (AF) is configured to send a trigger request. The network exposure function (NEF) is configured to cooperate with the AF to receive the trigger request and is further configured to generate a request for obtaining a short message service function ID (SMSF ID) corresponding to the at least one user equipment. The unified data management (UDM) is configured to cooperate with the NEF to receive the generated request and is further configured to fetch an assigned SMSF ID corresponding to the at least one user equipment and transmit the assigned SMSF ID to the NEF. The service capability exposure function (SCEF) is configured to cooperate with the NEF to receive the assigned SMSF ID via an interworking unit and is further configured to submit the SMSF ID along with the trigger request to a network element. The network element is configured to select a session SMSF corresponding to the assigned SMSF ID.

In an embodiment, the SCEF is configured to initiate a new diameter connection towards the network element having a plurality of SMSF identities (SMSF IDs).

In an embodiment, the network element includes an internet protocol service management (IPSM) unit or a short message service centre (SMSC) unit.

In an embodiment, the network element is configured to initiate a

mobile terminated (MT) delivery request and transmit the mobile terminated (MT) delivery request to the SMSF.

In an embodiment, the interworking unit is a NEF interface.

In an embodiment, the network element is configured to buffer data associated with the at least one user equipment is not reachable and is further configured to receive the trigger request from a home subscriber server (HSS) having a mobility management entity (MME) identity based on which the buffered data is delivered.

The present disclosure discloses a method for triggering at least one user equipment in a network. The method includes receiving, by a network exposure function (NEF), a trigger request and generating a request for obtaining a short message service function ID (SMSF ID) corresponding to the at least one user equipment. The method includes receiving, by a unified data management (UDM), the generated request and fetching an assigned SMSF ID corresponding to the at least one user equipment and transmitting the assigned SMSF ID to the NEF. The method includes receiving, by a service capability exposure function (SCEF), the assigned SMSF ID via an interworking unit and submitting the SMSF ID along with the trigger request to a network element. The method includes selecting, by the network element, a SMSF corresponding to the assigned SMSF ID.

In an embodiment, the method includes a step of authentication performed by the NEF after receiving the trigger request.

In an embodiment, the NEF (114) is configured to send the assigned SMSF ID to the SCEF, eliminating diameter interface between the NEF (114) and the network element.

In an embodiment, the method further includes a step of buffering, the network element, data associated with of the at least one user equipment is not reachable and is further configured to receive the trigger request from a home subscriber server (HSS) having a mobility management entity (MME) identity based on which the buffered data is delivered.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that the invention of such drawings includes the invention of electrical components, electronic components, or circuitry commonly used to implement such components.

FIG. 1 illustrates an exemplary a system for triggering at least one user equipment in a network, in accordance with an embodiment of the present disclosure.

FIG. 2 illustrates an exemplary block diagram of the system, in accordance with an embodiment of the present disclosure.

FIG. 3 illustrates an exemplary method for triggering at least one user equipment in a network, in accordance with an embodiment of the present disclosure.

FIG. 4 illustrates is an illustration of a non-limiting example of details of computing hardware used in the system, in accordance with an embodiment of the present disclosure.

The foregoing shall be more apparent from the following more detailed description of the invention.

### LIST OF REFERENCE NUMERALS

100—System
102—User
104—User Equipment
110—Interworking Unit
112—Application Function
114—Network Exposure Function (NEF)
116—Service Capability Exposure Function (SCEF)
118—Unified Data Management (UDM)
120—Home Subscriber Server (HSS)
122—Internet Protocol Service Management (IPSM) Unit
124—short message Service Function (SMSF) Unit
126—Mobility Management Entity (MME)/Access and Mobility Management Function (AMF)
202—One or more processor(s)
204—Memory
206—A Plurality of Interfaces
208—Processing Engine
210—receiving engine
212—Conversion Engine
214—Transmitting Engine
216—Other Engines/Units
218—Database
410—External Storage Device
420—Bus
430—Main Memory
440—Read Only Memory
450—Mass Storage Device
460—Communication Port
470—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), fifth generation (5G), and now sixth generation (6G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

At present, 3GPP teaches a little about integration and feature-related aspects supported by network nodes. The absence of a clear depiction of the interaction between 4G and 5G nodes, such as SCEF and NEF, generates a complex architecture. The present disclosure simplifies network architecture by disclosing a method and a system for sending triggering message in 5G. The present implementation reduces the efforts to develop diameter interface between NEF and SMSC/IPSM.

The present disclosure discloses a system for triggering elements in 5G network that includes an interworking unit. The interworking unit is configured to allow exchange of request message/trigger message between 4G and 5G nodes such as Service Capability Exposure Function (SCEF) and Network Exposure Function (NEF). The interworking unit is configured to convert the request message/trigger message from one node into a format that is compatible with the other node.

The present disclosure provides a system and a method for triggering 5G network elements. The present disclosure provides a system and a method that mitigates issues associated with triggering UE or network elements/entities. The present disclosure provides a system and a method that handles interworking between Evolved Packet Core (EPC) and 5G core (5GC) in network exposure scenarios. The present disclosure provides a system and a method that enables designing of flows and interfaces between 4G and 5G nodes such as SCEF and NEF. The present disclosure provides a system and a method that supports use of N33 and T8 application programming interfaces (APIs) by application functions (AFs).

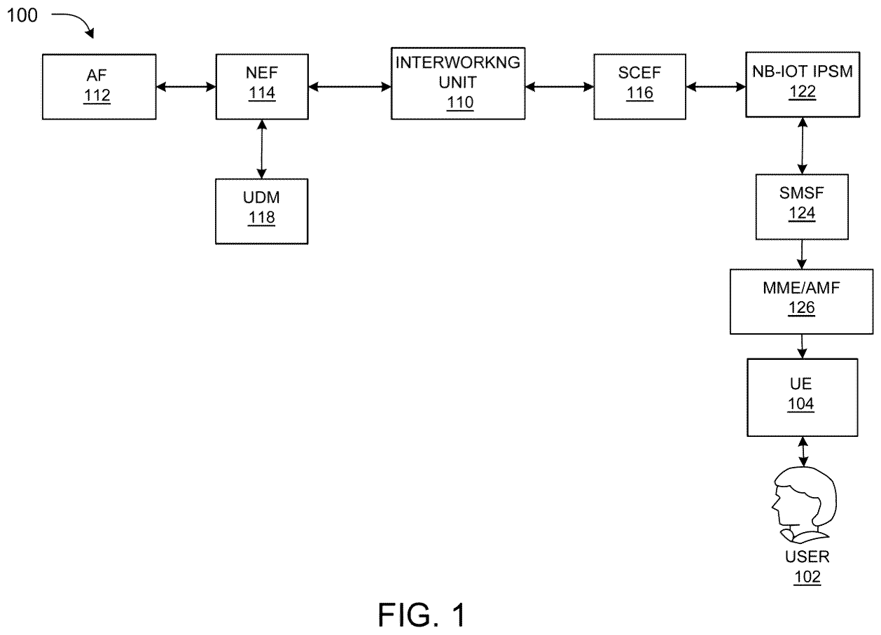

The various embodiments throughout the disclosure will be explained in more detail with reference to FIG. 1-FIG. 4.

FIG. 1 illustrates an exemplary system for triggering at least one user equipment in a network (referred as “system 100”), in accordance with an embodiment of the present disclosure.

Referring to FIG. 1, the system (100) includes one or more users (102) using a corresponding UE (104). The one or more UEs (104) is capable of communicating with a centralized server or other UE (104). Although, the UE (104) is considered as an example device in FIG. 1 to be triggered, in embodiments, any network element can be configured to be triggered as per the inventive aspects of disclosure.

In an embodiment, the one or more UEs (104) may include, but not limited to, any electrical, electronic, electro-mechanical or an equipment or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user (102) such as touch pad, touch enabled screen, electronic pen, receiving devices for receiving any audio or visual signal in any range of frequencies and transmitting devices that can transmit any audio or visual signal in any range of frequencies. It may be appreciated that the UEs (104) may not be restricted to the mentioned devices and various other devices may be used. As shown in FIG. 1, the system (100) includes an application function (AF) (112), a network exposure function (NEF) (114), a unified data management (UDM) (118), a service capability exposure function (SCEF) (116), a network element (122), and a short message service function (SMSF) (124), which may be part of a network to which UE 104 is communicatively coupled. Initially, the UE (104) may receive a connection request. The network may receive acknowledgment from the UE (104).

When the AF (112) needs to trigger the UE (104) to perform some action, the AF (112) requests the NEF (114) to send a trigger request to the UE. To this end, the AF (112) may invoke an Nnef Trigger service to request the network to send the trigger request to the UE.

At first step, the AF (112) determines the need to trigger a device (e.g., UE, any network element). If the AF (112) has no contact details for the NEF (114), it may discover and select NEF services. The AF (112) communicates with the NEF (114) to invoke an Nnef Trigger Delivery service operation to request that a trigger request be sent to the UE. The NEF (114) checks that the AF (112) is authorized to send a trigger request and that the AF (112) has not exceeded its trigger commit quota or rate on NEF.

The AF (112) is configured to send a trigger request (trigger delivery request). In an embodiment, the NEF (114) is configured to interact with the UDM (118). The NEF (114) is configured to cooperate with the AF to receive the trigger request. After receiving the trigger request, the NEF is further configured to generate a request for obtaining a short message service function ID (SMSF ID) corresponding to the at least one user equipment. The NEF (114) which is configured to generate a request for obtaining a SMSF ID corresponding to a specific element (specific UE). The NEF (114) invokes the Nudm_UECM_Get service operation (e.g., with SUPI, SMS) to retrieve the UE SMSF identities. In an example, the trigger request may include a number of information (e.g., GPSI, SUPI, AF Identifier, trigger reference number, validity period, priority, SMSF serving node ID(s) (if available, are obtained from the UDM (118)), SMS Application port ID, trigger payload, Trigger Indication). In an example, the Nudm_UECM request may have “NF Type” header containing “NEF” as its value. On receiving this type of “Nudm_UECM request”, the UDM (118) shall return SMSF ID in case of 5G UE attachment. The UDM (118) is configured to cooperate with the NEF (114) to receive the generated request. On receiving the generated request from the NEF (114), the UDM (118) is further configured to fetch an assigned SMSF ID corresponding to the at least one user equipment and transmit the assigned SMSF ID to the NEF (114). In an embodiment, the NEF (114) transmits the request (query) (Nudm_UECM_Get) to the UDM (118) for obtaining the identity of a 5G enabled UE (104) from the UDM (118).

In an example, the NEF (114) transmits the request to the SMSF (124). In an embodiment, the query (Nudm_UECM_Get) includes a header indicative of “NF Type” having “NEF” as its value. In an embodiment, on receiving the query, the UDM (118) fetch and return an assigned SMSF ID associated with the UE (104). In an embodiment, the UDM (118) may invoke, for example, the Nudr_DM_Query service to retrieve the UE SMSF identities. The UDM (118) provides, for example, a Nudm_UECM_Get response with the corresponding UE

SMSF identities. In an embodiment, a UDM policy may influence which serving node identities are returned. The SCEF (116) is configured to cooperate with the NEF (114) to receive the assigned SMSF ID via the interworking unit (110) and is further configured to submit the SMSF ID along with the trigger request to a network element. For example, the interworking unit (110) is a NEF interface. In an aspect, the interworking unit (110) is configured to employ conversion of Hypertext Transfer Protocol (HTTP) version 2 (HTTP2) to Hypertext Transfer Protocol (HTTP) version 1 (HTTP1) to convey SMSF ID to the SCEF (116). In an embodiment, the NEF (114) sends a subscription and the received assigned SMSF ID towards the SCEF (116) via the interworking unit (110). In an embodiment, the interworking unit (110) allows avoidance of a diameter interface between the NEF (114) and the network element. In an aspect, the interworking unit (110) receives the request from the NEF (114), converts the request into a format compatible with the SCEF, and transmits the converted request thereto. In an example, the network element is an Internet Protocol Service Management (IPSM) unit (122) or a Short Message Service Center (SMSC) unit. In an embodiment, the IPSM unit (122)/SMSC unit serves as a component responsible for managing IP-based services and handling Short Message Service (SMS) functions. In an embodiment, the IPSM unit (122) or the SMSC unit delivers data and triggers to the UE (104).

Further, the NEF (114) sends the SMSF ID associated with the UE (104) to the SCEF (116). Further, the SCEF submits the SMSF ID along with the trigger request to the network element to SMSF.

In an aspect, the SMSC unit performs Mobile Terminated (MT) SMS delivery. The SMSC unit may provide the routing information to the SMS Gateway

Mobile Services Switching Center (GMSC) to avoid UDM interrogation. The SMSC unit generates the necessary Call Detail Record (CDR) information and includes the AF Identifier.

In an embodiment, the SCEF (116) initiates a new diameter connection with the IPSM unit (122) or the SMSC unit. In an embodiment, the diameter connection includes the SMSF identities (SMSF IDs) received by the SCEF (116) from the NEF (114). In an embodiment, the diameter connection allows exchanging of data between the SCEF (116) and the IPSM unit (122)/SMSC unit.

The network element is configured to select a SMSF corresponding to the assigned SMSF ID. In an aspect, the network element is configured to initiate a mobile terminated (MT) delivery request and transmit the mobile terminated (MT) delivery request to the SMSF. The SMSF is configured to transmit the mobile terminated (MT) delivery request to the UE via a Mobility Management Entity (MME) (126A)/Access and Mobility Management Function (AMF) (126B).

In an embodiment, the IPSM unit (122) or the SMSC unit transmits the trigger delivery request (to a Mobility Management Entity (MME) (126A)/Access and Mobility Management Function (AMF) (126B) (collectively referred to as MME/AMF (126)) via the SMSF (124). In an embodiment, the MME (126A) is a component in the 4G Long-Term Evolution (LTE) EPC network, while the AMF (126B) is a counterpart component in the 5G core network. In an embodiment, the MME/AMF (126) provides functions including, but not limited to, tracking, handovers, and authentication of the UEs (104). In response to the received request (mobile terminated (MT) delivery request), the UE (104) takes specific actions and may take into consideration the content of the trigger payload. This action typically involves an initiation of immediate or later communication with the AF. In an example, the UE may initiate immediate or later communication with the application server based on the information contained in the trigger payload, which may include the PDU Session Establishment procedure if the related PDU Session is not already established. Thus, in order to ensure that the application runs normally, the network needs to successfully deliver the application trigger to the UE.

In an example, the network element is configured to buffer data associated with the at least one UE (104) when the UE (104) is not reachable and is further configured to receive the trigger request from a home subscriber server (HSS) having a mobility management entity (MME) identity based on which the buffered data is delivered. In an embodiment, if a delivery report is enabled, no buffering of data occurs at the IPSM unit (122) or the SMSC unit. In such embodiments, a Diameter Routing Rule (DRR) is applied for the 5GC diameter connection between SCEF (116) and IPSM unit (122) or SMSC unit. In another embodiment, if data buffering occurs at the IPSM UNIT (122)/SMSC due to non-reachability of the UE (104) in the 5GC, and the UE (104) subsequently attaches to the EPC network, then the IPSM unit (122) or the SMSC unit receives a trigger request from a Home Subscriber Server (HSS) (120) over an soc interface. In an embodiment, the trigger request includes the MME identity based on which the buffered data is delivered over the EPC network instead of the 5G core network, or vice versa.

In an embodiment, each type of request message/trigger message exchanged between the NEF (114) and the SCEF (116) includes a plurality of input/header information.

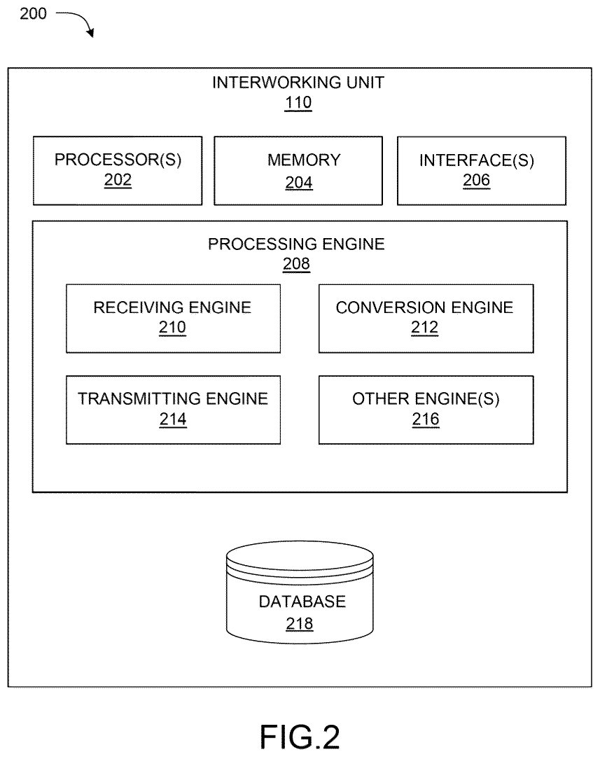

FIG. 2 illustrates an exemplary block diagram (200) of the system (100) in accordance with an embodiment of the present disclosure. In an example, the system (100) may be implemented as the interworking unit (110) in a network architecture.

In an aspect, the system (100) (interworking unit (110)) may include one or more processor(s) (202). The one or more processor(s) (202) is implemented as one or more microprocessors, microcomputers, microcontrollers, edge or fog microcontrollers, digital signal processors, central processing units, logic circuitries, and/or any devices that process data based on operational instructions. Among other capabilities, one or more processor(s) (202) is configured to fetch and execute computer-readable instructions stored in a memory (204). The memory (204) is configured to store one or more computer-readable instructions or routines in a non-transitory computer-readable storage medium, which is fetched and executed to create or share data packets over a network service. The memory (204) may comprise any non-transitory storage device including, for example, volatile memory such as Random-Access Memory (RAM), or non-volatile memory such as Erasable Programmable Read-Only Memory (EPROM), flash memory, and the like.

In an embodiment, the interworking unit (110) includes an interface(s) (206). The interface(s) (206) may include a variety of interfaces, for example, interfaces for data input and output devices, referred to as I/O devices, storage devices, and the like. The interface(s) (206) may facilitate communication of the interworking unit (110). The interface(s) (206) may also provide a communication pathway for one or more components of the interworking unit (110). Examples of such components include, but are not limited to, processing unit/engine(s) (208) and a database (218).

In an embodiment, the processing unit/engine(s) (208) is implemented as a combination of hardware and programming (for example, programmable instructions) to implement one or more functionalities of the processing engine(s) (208). In examples described herein, such combinations of hardware and programming are implemented in several different ways. For example, the programming for the processing engine(s) (208) is processor executable instructions stored on a non-transitory machine-readable storage medium (for example, computer program product) and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the interworking unit (110) includes the machine-readable storage medium storing the instructions and the processing resource to execute the instructions, or the machine-readable storage medium is separate but accessible to the interworking unit (110) and the processing resource. In other examples, the processing engine(s) (208) is implemented by electronic circuitry.

In an embodiment, the processing engine (208) may include one or more engines selected from any of a receiving engine (210), a conversion engine (212), a transmitting engine (214), and other engines/units (216).

In an embodiment, the receiving engine (210) is configured to receive the request message/trigger message from either the NEF (114) or the SCEF (116). In an embodiment, the interworking unit (110) is implemented as a computing device or a server that functions as an API. In an embodiment, the receiving engine (210) is configured to receive the create, retrieve, update, or delete request message along with associated parameters.

In an embodiment, the conversion engine (212) is configured to convert the request message received in a format compatible with NEF (114) to a format compatible with SCEF (116), and vice versa. In an embodiment, the conversion engine (212) may enable interworking between the NEF (114) and the conversion engine (212).

In an embodiment, the transmitting engine (214) is configured to

transmit the response generated by the conversion engine (212) to the appropriate 5G network element. In an embodiment, the response is transmitted to SCEF (116) if the request message was received from the NEF (114), and vice versa.

In an alternate embodiment, the interworking unit (110) may be a converged NEF. The converged NEF (CNEF) includes a proprietary interface between the NEF (114) and the SCEF (116). In some implementations, the CNEF may be a customized combination of SCEF and NEF. The CNEF allows exposure to network capabilities of 4G as well as 5G core.

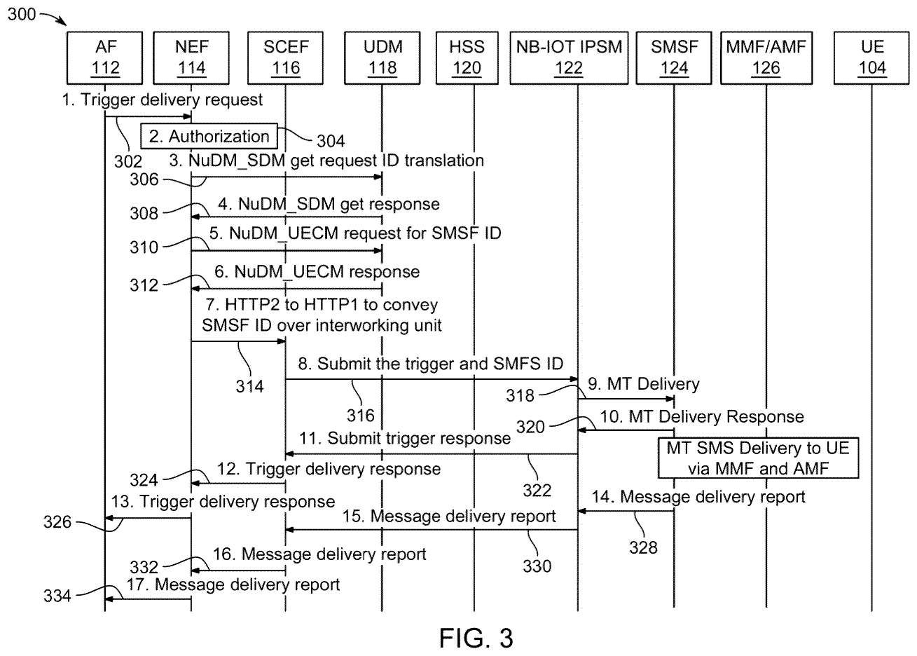

FIG. 3 illustrates an exemplary method (300) for triggering at least one user equipment in a network, in accordance with an embodiment of the present disclosure.

At step (302), an AF (112) initiates a trigger delivery request to the NEF (114). In examples, the device may be a UE or any network element. At step (304), the NEF (114) is configured to authenticate the received trigger request. At step (306), the NEF (114), after authorizing the request, transmits a “NuDM_SDM Get” request towards the UDM (118) for ID translation In an embodiment, the UDM (118) transmits a “NuDM_SDM Get” response to the NEF (114) (step 308). At step (310), the NEF (114) transmits a “NuDM_UECM” get request to obtain the SMSF ID associated with the UE (104). At step (312), the UDM (118) responds back to the NEF (114) with the SMSF ID of the requested UE (104). In an embodiment, the NEF (114) sends hypertext transfer protocol 2 (HTTP2) to HTTP1 request along with the SMSF ID to the SCEF (116) via the interworking unit (110).

At step (314), the interworking unit (110) receives the SMSF ID from the NEF (114) in the form of an API request in accordance with its API specifications. At step (316), the SCEF (116) submits the trigger request and the SMSF ID to the IPSM UNIT (122). In an embodiment, the IPSM UNIT (122) is implemented on a Narrowband Internet of Things IP Service Management (NB-IoT IPSM) node. At step (318), the IPSM UNIT (122) initiates a Mobile Terminated (MT) delivery request to the SMSF (124). At step (320), the, SMSF (124) returns a response having the requested data. In an embodiment, the SMSF (124) interfaces with the MME/AMF (126) to deliver a trigger message/service to the UE (104) (at steps (324, 326). In an embodiment, the SMSF (124) also transmits a message delivery report when the trigger message/service is delivered to the UE (104) (at steps 328).

At step (322), the IPSM UNIT (122) submits a trigger response to the SCEF (116). The trigger delivery response is then relayed to the AF (112) via the NEF (114). Further, the IPSM UNIT (122) may also relay the message delivery report to the AF (112) via the SCEF (116) and the NEF (114) (steps 330, 332, 334). In an embodiment, the interworking unit (110) facilitates the exchange of data between the NEF (114) and the SCEF (116).

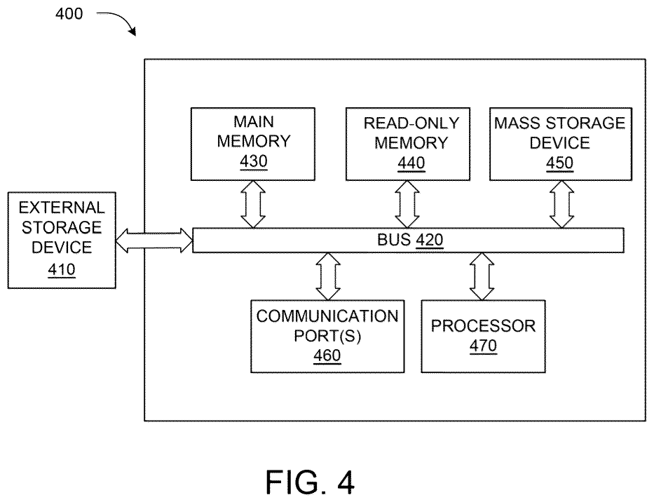

FIG. 4 is an illustration (400) of a non-limiting example of details of computing hardware used in the system (100), in accordance with an embodiment of the present disclosure. As shown in FIG. 4, the system (100) may include an external storage device (410), a bus (420), a main memory (430), a read only memory (440), a mass storage device (450), a communication port (460), and a processor (470). A person skilled in the art will appreciate that the system (100) may include more than one processor (470) and communication ports (460). Processor (470) may include various modules associated with embodiments of the present disclosure.

In an embodiment, the communication port (460) is any of an RS-232 port for use with a modem-based dialup connection, a 10/100 Ethernet port, a Gigabit or 10 Gigabit port using copper or fiber, a serial port, a parallel port, or other existing or future ports. The communication port (460) is chosen depending on a network, such as a Local Area Network (LAN), Wide Area Network (WAN), or any network to which the system (100) connects.

In an embodiment, the memory (430) is Random Access Memory (RAM), or any other dynamic storage device commonly known in the art. Read-only memory (440) is any static storage device(s) e.g., but not limited to, a Programmable Read Only Memory (PROM) chips for storing static information e.g., start-up or Basic Input/Output System (BIOS) instructions for the processor (470).

In an embodiment, the mass storage (450) is any current or future mass storage solution, which is used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (420) communicatively couples the processor(s) (470) with the other memory, storage, and communication blocks. The bus (420) is, e.g., a Peripheral Component Interconnect (PCI)/PCI Extended (PCI-X) bus, Small Computer System Interface (SCSI), Universal Serial Bus (USB) or the like, for connecting expansion cards, drives and other subsystems as well as other buses, such a front side bus (FSB), which connects the processor (470) to the system (400).

Optionally, operator and administrative interfaces, e.g., a display, keyboard, joystick, and a cursor control device, may also be coupled to the bus (420) to support direct operator interaction with the system (400). Other operator and administrative interfaces are provided through network connections connected through the communication port (460). Components described above are meant only to exemplify various possibilities. In no way should the aforementioned exemplary illustration (400) limit the scope of the present disclosure.

The present disclosure is configured to provide a system (100) and a method for initiating actions or events within a network. In an aspect, various network elements include devices, servers, routers, or other components within the 5G network infrastructure. The primary target of the system (100) is the triggering of user equipment. In the context of 5G, user equipment refers to the devices used by end-users, such as smartphones, tablets, IoT devices, and other connected gadgets. The system (100) alleviates one or more issues related to triggering both UE devices and other network elements within 5G networks. These issues could encompass challenges such as latency, reliability, efficiency, or other concerns that may arise during the process of triggering. The system (100) may be placed within a 5G communication network that may involve various algorithms, protocols, or mechanisms to enhance the efficiency and reliability of triggering events, ensuring a smoother operation of user equipment and network elements in 5G networks.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

### ADVANTAGES OF THE PRESENT DISCLOSURE

The present disclosure provides a system (100), and a method for triggering 5G and advanced network elements.

The present disclosure provides a system (100), and a method that mitigates issues associated with triggering user equipment (UE) or network elements/entities.

The present disclosure provides a system (100), and a method that handle interworking between Evolved Packet Core (EPC) and 5G core (5GC) in network exposure scenarios.

The present disclosure provides a system (100), and a method that enable designing of flows and interfaces between 4G and 5G nodes such as Service Capability Exposure Function (SCEF) and Network Exposure Function (NEF).

The present disclosure provides a system (100), and a method that support use of N33 and T8 Application Programming Interfaces (APIs) by Application Functions (AFs).

The present disclosure provides a system (100), and a method for triggering network elements in 6G and beyond networks.

We claim:

1. A system (100) for triggering at least one device (104) in a network, said system (100) comprising:
an application function (AF) (112) configured to send a trigger request;
a network exposure function (NEF) (114) configured to cooperate with said AF (112) to receive said trigger request and is further configured to generate a request for obtaining a short message service function ID (SMSF ID) corresponding to said at least one device;
a unified data management (UDM) (118) configured to cooperate with said NEF (114) to receive said generated request and is further configured to fetch an assigned SMSF ID corresponding to said at least one device and transmit said assigned SMSF ID to said NEF (114);
a service capability exposure function (SCEF) (116) configured to cooperate with said NEF (114) to receive said assigned SMSF ID via an interworking unit (110), and is further configured to submit said SMSF ID along with said trigger request to a network element (122); and
said network element (122) is configured to select a short message service function (SMSF) (124) corresponding to said assigned SMSF ID.

2. The system (100) as claimed in claim 1, wherein said SCEF (116) is configured to initiate a new diameter connection towards said network element (122) having a plurality of SMSF identities (SMSF IDs).

3. The system (100) as claimed in claim 1, wherein said network element (122) includes an internet protocol service management (IPSM) unit or a short message service center (SMSC) unit.

4. The system (100) as claimed in claim 1, wherein said network element (122) is configured to initiate a mobile terminated (MT) delivery request and transmit said mobile terminated (MT) delivery request to said SMSF.

5. The system (100) as claimed in claim 1, wherein said interworking unit (110) is a NEF interface.

6. The system (100) as claimed in claim 1, wherein said network element (122) is configured to buffer data associated with said at least one device is not reachable, and is further configured to receive said trigger request from a home subscriber server (HSS) having a mobility management entity (MME) identity based on which said buffered data is delivered.

7. A method (300) for triggering at least one device (104) in a network, said method (300) comprising:
receiving, by a network exposure function (NEF) (114), a trigger request from an application function (AF) (112), and generating a request for obtaining a short message service function ID (SMSF ID) corresponding to said at least one device;
receiving, by a unified data management (UDM) (118), said generated request and fetching an assigned SMSF ID corresponding to said at least one device and transmitting said assigned SMSF ID to said NEF (114);
receiving, by a service capability exposure function (SCEF) (116), said assigned SMSF ID via an interworking unit (110), and submitting said SMSF ID along with said trigger request to a network element (122); and
selecting, by said network element (122), a SMSF (124) corresponding to said assigned SMSF ID.

8. The method (300) as claimed in claim 7, further comprising a step of authentication performed by said NEF (114) after receiving said trigger request.

9. The method (300) as claimed in claim 7, wherein said NEF (114) is configured to send said assigned SMSF ID to said SCEF, eliminating diameter interface between said NEF (114) and said network element.

10. The method (300) as claimed in claim 7, further comprising a step of buffering, said network element, data associated with of said at least one device is not reachable, and is further configured to receive said trigger request from a home subscriber server (HSS) having a mobility management entity (MME) identity based on which said buffered data is delivered.

11. A computer program product comprising a non-transitory computer-readable medium comprising instructions that, when executed by one or more processors, cause the one or more processors to perform a method (300) for triggering at least one device (104) in a network, said method (300) comprising:
receiving, by a network exposure function (NEF) (114), a trigger request from an application function (AF) (112), and generating a request for obtaining a short message service function ID (SMSF ID) corresponding to said at least one device;
receiving, by a unified data management (UDM) (118), said generated request and fetching an assigned SMSF ID corresponding to said at least one device and transmitting said assigned SMSF ID to said NEF (114);
receiving, by a service capability exposure function (SCEF) (116), said assigned SMSF ID via an interworking unit (110), and submitting said SMSF ID along with said trigger request to a network element (122); and
selecting, by said network element (122), a session management service function (SMSF) (124) corresponding to said assigned SMSF ID.

12. A user equipment (UE) (102) communicatively coupled with a network, said coupling comprises steps of:
receiving a connection request;
sending an acknowledgment of the connection request to the network;
transmitting a plurality of signals in response to the connection request, wherein said network is configured to trigger the UE (104) as claimed in claim 7.
